(19) United States
(12) Patent Application Publication
(10) Pub. No.: US 2019/0136859 A1
(43) Pub. Date: May 9, 2019

(54) SIMPLIFIED ROOTS-TYPE BLOWER

(71) Applicant: Eaton Intelligent Power Limited, Dublin 4 (IE)

(72) Inventors: William Nicholas EYBERGEN, Harrison Twp, MI (US); Kelly Ann WILLIAMS, South Lyon, MI (US)

(21) Appl. No.: 16/028,097

(22) Filed: Jul. 5, 2018

Related U.S. Application Data
(63) Continuation of application No. 14/094,044, filed on Dec. 2, 2013, now abandoned.
Application No. 14/094,044 is a continuation of application No. PCT/US2012/040736, filed on Jun. 4, 2012.
(60) Provisional application No. 61/492,520, filed on Jun. 2, 2011.

(51) Int. Cl. F04C 29/06; F04C 18/12; F04C 18/08; F04C 2/12; F04C 29/00

(52) U.S. Cl. CPC F04C 29/06; F04C 18/126; F04C 18/086; F04C 2/126; F05C 2253/04; F04C 29/005; F04C 2230/60; Y10T 29/49242; F05C 2225/00

(57) ABSTRACT

The present disclosure relates to a simplified roots-type blower having an improved sound signature. The roots-type blower includes a rotor bore housing having a molded, one-piece polymeric construction. The rotor bore housing defines a first rotor bore and a second rotor bore. The rotor bore housing also defines a first bearing pocket corresponding to the first rotor bore and a bearing pocket corresponding to the second rotor bore axis. The rotor bore housing further defining a timing gear chamber.

### CROSS REFERENCE TO RELATED APPLICATIONS

This application is a Continuation of PCT/US2012/040736, filed 4 Jun. 2012, which claims benefit to U.S. Patent Application Ser. No. 61/492,520 filed on 2 Jun. 2011 and which applications are incorporated herein by reference. To the extent appropriate, a claim of priority is made to each of the above disclosed applications.

### TECHNICAL FIELD

The present disclosure relates generally to blowers. More particularly, the present disclosure relates to blowers such as roots-type air blowers.

### BACKGROUND

Roots-type air blowers are positive displacement pumps that move air through the use of intermeshing rotors. The rotors are mounted within rotor bores defined by a rotor bore housing. The rotors are typically supported within bearings mounted within a bearing plate assembly that attaches to the rotor bore housing. The bearings function to locate the rotors in the bearing plate and are press-fit into pockets machined in the bearing plate. A relatively high degree of precision is needed to ensure that no contact is made between the rotors or between the rotors and the rotor bore housing. Thus, the bearing plate assembly and the rotor bore housing are manufactured from metal using tightly controlled assembly and machining operations. In view of the above, there is a need for simplified roots-type blower designs that can be manufactured in a cost-effective manner while still being capable of efficient operation.

Another challenge for current roots-type blower designs relates to noise production. For example, current roots-type blower designs typically generate noise when high pressure air at the outlet in-rushes into the atmospheric air transported by the rotors. This air pulsation at the outlet is audible and can be amplified by the typical housing and bearing plate materials used to manufacture current roots-type blowers. Furthermore, audible timing gear rattle resulting from engine torque is also amplified by the current materials used to manufacture existing roots-type blowers. Therefore, improvements in the area of noise dampening are also needed.

### SUMMARY

One aspect of the present disclosure relates to a simplified roots-type blower having a molded polymeric rotor bore housing with integrally molded bearing pockets. This type of design eliminates the need for machining.

Another aspect of the present disclosure relates to a roots-type blower having a molded, polymeric rotor bore housing and rotors designed with sharp edges which cut the housing to an exact size during the run-in period at start up thereby improving volumetric and thermal efficiency. As the rotors are rotated during the initial run-in period, the peripheral edges of the rotors cut away portions of the housing defining the rotor bores such that the inner shapes of the rotor bores match the outer shape defined by the peripheral edges of the rotors as the rotors are rotated about their respective axes. In certain embodiments, at least portions of the rotor bores are intentionally molded slightly undersized to allow the undersized portions of the rotor bores to be cut away by the rotors during the initial run-in period at startup.

A further aspect of the present disclosure relates to a roots-type blower molded or otherwise constructed of a polymeric (e.g., plastic) material having dampening properties that assist in reducing timing gear rattle and limiting the amplification of air pulsation related noise. In one embodiment, the use of dampening plastic materials combined with a design having bearing pockets and rotor bores integrated into the same housing piece can reduce the pulsation noise and gear rattle typical of conventional roots-type blowers. In certain embodiments, the use of plastic timing gears or the combination of metal (e.g., steel) and plastic timing gears can have a significant impact on reducing gear rattle.

A further aspect of the present disclosure relates to a roots-type blower having an injection molded, single-piece housing that includes rotor bores and bearing pockets integrated therein. In certain embodiments, bearings are molded within the bearing pockets using an insert molding technique. In certain embodiments, the polymeric material of the housing is reinforced with reinforcing members such as glass fibers. In certain embodiments, glass fibers are specifically oriented to enhance part precision and structural integrity. In certain embodiments, the molded, polymeric housing defining the rotor bores and the bearing pockets connects with an inlet housing having a metal construction. In certain embodiments, an alignment/pilot interface is provided between the metal, inlet housing and the molded, plastic rotor bore housing. The alignment interface can be configured to assist in improving or maintaining concentricity of the rotor bores.

Still another aspect of the present disclosure relates to a compact roots-type blower having rotor bearings mounted directly above an outlet of the roots-type blower. In one embodiment, the roots-type blower includes rotor bores, rotors rotationally mounted within the rotor bores, rotor timing gears mounted at one end of the roots-type blower and a rotor drive pulley mounted at an opposite end of the roots-type blower. In such an embodiment, the rotor bores are positioned between the drive pulley and the rotor timing gears. In certain embodiments, the inlet of the roots-type blower is positioned generally adjacent the second end of the roots-type blower and the outlet of the roots-type blower is positioned generally adjacent to the first end of the roots-type blower.

Still another aspect of the present disclosure relates to a roots-type blower including a rotor bore housing having a molded polymeric construction. The rotor bore housing defines a first rotor bore aligned along a first rotor bore axis and a second rotor bore aligned along a second rotor bore axis. The first and second rotor bore axes are parallel. The rotor bore housing also defines a first bearing pocket co-axially aligned with the first rotor bore axis and a second bearing pocket co-axially aligned with the second rotor bore axis. The rotor bore housing further defines a gear chamber. The roots-type blower also includes a first bearing mounted within the first bearing pocket and a second bearing mounted within a second bearing pocket. The roots-type blower further includes a first roots-type rotor having a first rotor shaft aligned along the first rotor bore axis and a second roots-type rotor having a second rotor shaft aligned along the second rotor bore axis. The first rotor shaft is supported by the first bearing such that the first roots-type rotor is free to rotate relative to the rotor bore housing about the first rotor bore axis. The second rotor shaft is supported by the second bearing such that the second roots-type rotor is free to rotate relative to the rotor bore housing about the second rotor bore axis. The roots-type blower further includes first and second gears positioned within the gear chamber. The first gear is coupled to the first rotor shaft and the second gear is coupled to the second rotor shaft. The first and second gears intermesh with one another and are configured for transferring torque between the first and second rotor shafts. In certain embodiments, the rotor bore housing defines an outlet of the roots-type blower, and the roots-type blower further includes a metal inlet housing that attaches to the rotor bore housing. The inlet housing defines an inlet of the roots-type blower.

Still another aspect of the present disclosure relates to a roots-type blower including a rotor bore housing having a fiber reinforced polymeric construction. The rotor bore housing defines a first rotor bore and a second rotor bore. The rotor bore housing also defines a first bearing pocket corresponding to the first rotor bore and a second bearing pocket corresponding to the second rotor bore. The rotor bore housing further defines a gear chamber. The roots-type blower also includes a first bearing mounted within the first bearing pocket and a second bearing mounted within the second bearing pocket. The roots-type blower further includes a first roots-type rotor having a first rotor shaft and a second roots-type rotor having a second rotor shaft. The first roots-type rotor is positioned within the first rotor bore and the second roots-type rotor is positioned within the second rotor bore. The first and second rotor shafts are rotatable about rotor shaft axes that are positioned such that the first and second root-type rotors intermesh as the first and second roots-type rotors rotate. The first rotor shaft is supported within the first bearing and the second rotor shaft is supported by the second bearing. The roots-type blower further includes first and second gears positioned within the gear chamber. The first gear is coupled to the first rotor shaft and the second gear is coupled to the second rotor shaft. The first and second gears intermesh with one another and are configured for transferring torque between the first and second rotor shafts. In certain embodiments, the roots-type blower can also include an inlet housing that attaches to the rotor bore housing. The inlet housing can have a metal construction and can define an inlet of the roots-type blower that is in fluid communication with the first and second rotor bores. The rotor bore housing can define an outlet of the roots-type blower that is in fluid communication with the first and second rotor bores.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic depiction of a prior art roots-type blower;

FIG. 2 is a front, top perspective view of a roots-type blower in accordance with the principles of the present disclosure;

FIG. 3 is a rear, top perspective view of the roots-type blower of FIG. 2;

FIG. 4 is a rear, bottom perspective view of the roots-type blower of FIG. 2;

FIG. 5 is a front, bottom view of the roots-type blower of FIG. 2;

FIG. 6 is a top view of the roots-type blower of FIG. 2;

FIG. 7 is a rear view of the roots-type blower of FIG. 2;

FIG. 8 is a front view of the roots-type blower of FIG. 2;

FIG. 9 is a bottom view of the roots-type blower of FIG. 2;

FIG. 10 is an elevation view of a first side of the roots-type blower of FIG. 2;

FIG. 11 is an elevation view of a second side of the roots-type blower of FIG. 2;

FIG. 12 is a cross-sectional view taken along section line 12-12 of FIG. 8;

FIG. 13 is a cross-sectional view taken along section line 13-13 of FIG. 8;

FIG. 14 is a cross-sectional view taken along section line 14-14 of FIG. 8;

FIG. 15 is a top, front perspective view of the roots-type blower of FIG. 2 with an inlet housing of the roots-type blower removed;

FIG. 16 is a bottom, rear perspective view of the roots-type blower of FIG. 2 with a gear chamber cover removed;

FIG. 17 is a top, front perspective view of a rotor bore housing of the roots-type blower of FIG. 2;

FIG. 18 is a bottom, rear perspective view of the rotor bore housing of FIG. 17;

FIG. 19 is a top view of the rotor bore housing of FIG. 17;

FIG. 20 is a front view of the rotor bore housing of FIG. 17;

FIG. 21 is a rear view of the rotor bore housing of FIG. 17;

FIG. 22 is a bottom view of the rotor bore housing of FIG. 17;

FIG. 23 is an elevation view of a first side of the rotor bore housing of FIG. 17;

FIG. 24 is an elevation view of a second side of the rotor bore housing of FIG. 17;

FIG. 25 is a cross-sectional view of the rotor bore housing of FIG. 17;

FIG. 26 is another cross-sectional view of the rotor bore housing of FIG. 17;

FIG. 27 is a top, rear perspective view of an inlet housing of the roots-type blower of FIG. 2;

FIG. 28 is a bottom, front perspective view of the inlet housing of FIG. 27;

FIG. 29 is a top view of the inlet housing of FIG. 27;

FIG. 30 is a bottom view of the inlet housing of FIG. 27;

FIG. 31 is a rear view of the inlet housing of FIG. 27;

FIG. 32 is a front view of the inlet housing of FIG. 27;

FIG. 33 is an elevation view of a first side of the inlet housing of FIG. 27;

FIG. 34 is an elevation view of a second side of the inlet housing of FIG. 27;

FIG. 35 is a perspective view of the roots-type blower of FIG. 2;

FIG. 36 shows a roots-type blower embodiment where a protective shield separates the bearings from the rotor bore housing; and

FIG. 37 is a perspective view of the rotor bore housing of FIG. 17 diagrammatically showing a reinforcing fiber orientation scheme for the housing.

### DETAILED DESCRIPTION

The present disclosure relates generally to a roots-type blower having a simplified design adapted for providing an improved noise signature. For convenience and ease of explanation, various sides of the depicted embodiments have been designated as top, bottom, front and rear sides. It will be appreciated that such side designations are for convenience only and are not intended to limit how the device may be used. In this regard, it will be appreciated that embodiments in accordance with the principles of the present disclosure can be used in any orientation.

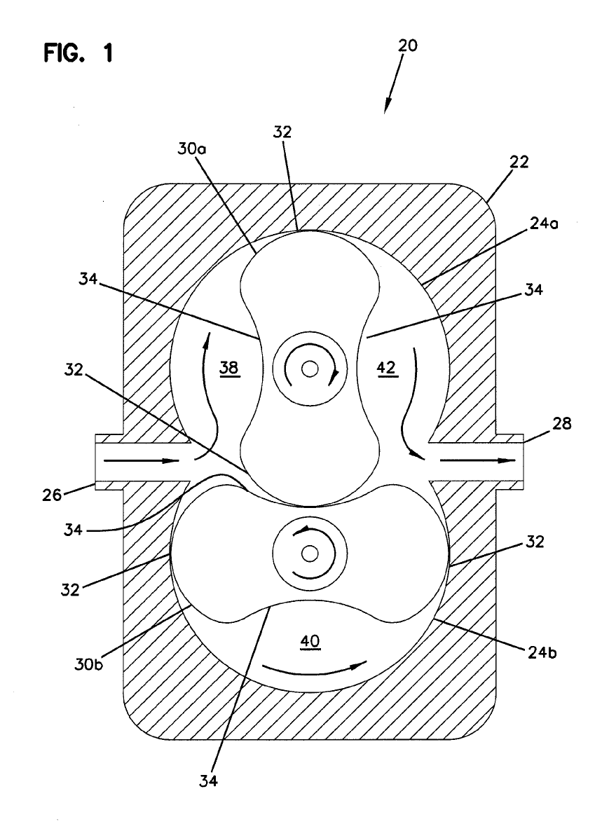

FIG. 1 shows a prior art roots-type blower 20. As used herein, the term “roots-type blower” means a blower having intermeshing rotors that cooperate to move air circumferentially through rotor bores of a rotor housing. As shown at FIG. 1, the roots-type blower 20 includes a rotor housing 22 defining first and second rotor bores 24a, 24b. The roots-type blower 20 includes an inlet 26 and an outlet 28 that are in fluid communication with the rotor bores 24a, 24b. A first rotor 30a is positioned within the first rotor bore 24a and a second rotor 30b is positioned within the second rotor bore 24b. The rotors 30a, 30b each include projections 32 and pockets 34. During operation of the roots-type blower 20, the rotors 30a, 30b are rotated about their central axes and intermesh with one another. Rotation of the rotors 30a, 30b is coordinated such that during rotation the projections 32 of the first rotor 30a are received within the pockets 34 of the second rotor 30b and the projections 32 of the second rotor 30b are received within the pockets 34 of the first rotor 30a. As the rotors 30a, 30b rotate air from the inlet 26 moves into the pockets 34 and is displaced circumferentially along the rotor bores 24a, 24b to the outlet 28. As shown at FIG. 1, region 38 corresponds to an air intake region where air moves from the inlet 26 into the rotor bore 24a, region 40 corresponds to a region where air is being moved by the rotor 30b circumferentially along the rotor bore from the inlet 26 toward the outlet 28, and region 42 represents a region where air within the rotor bore 24a is being moved from the rotor bore 24a to the outlet 28.

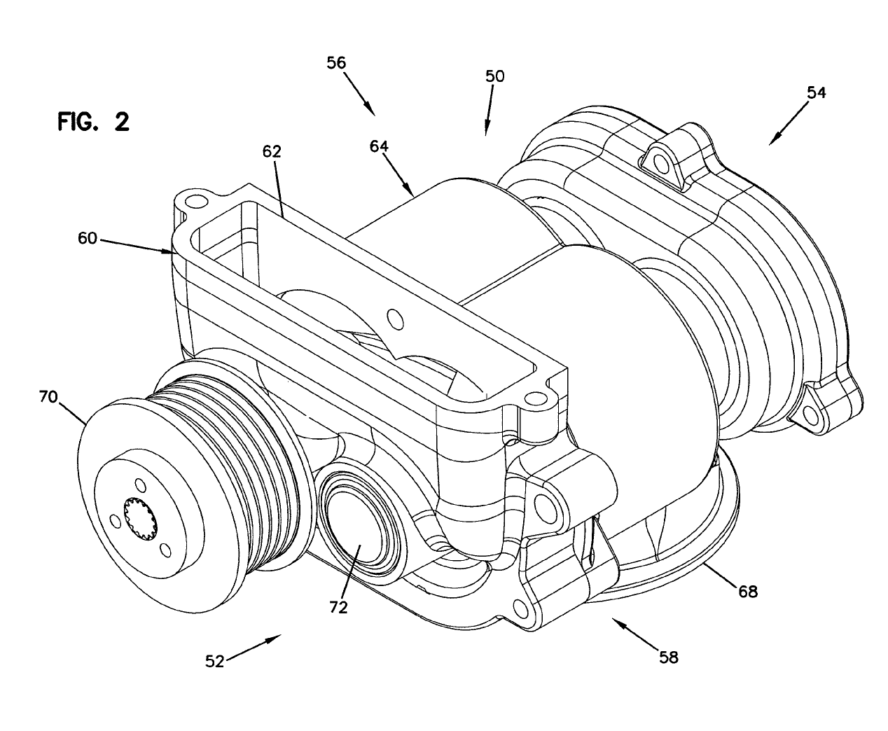

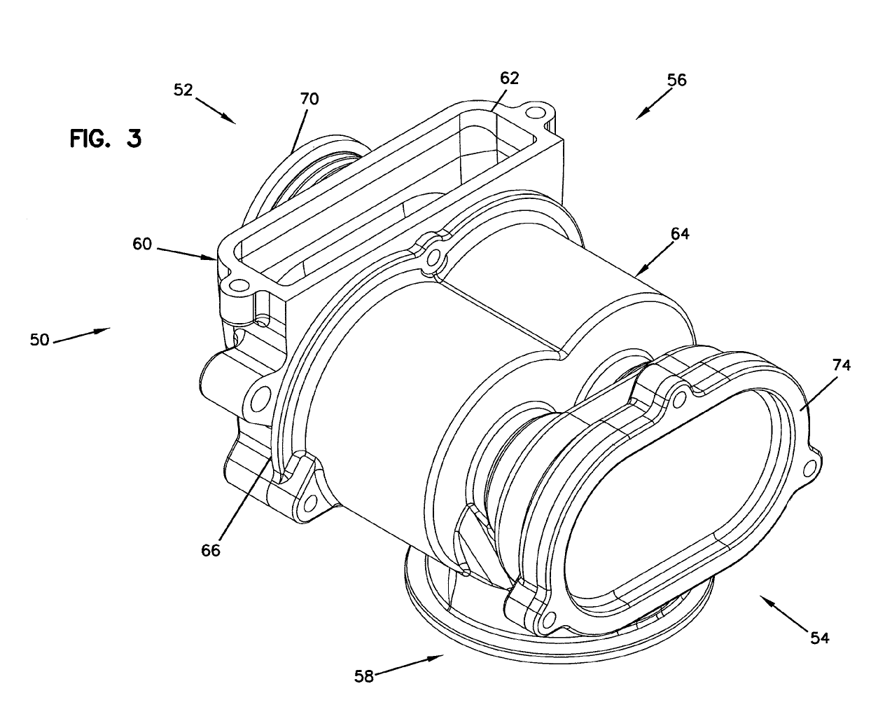

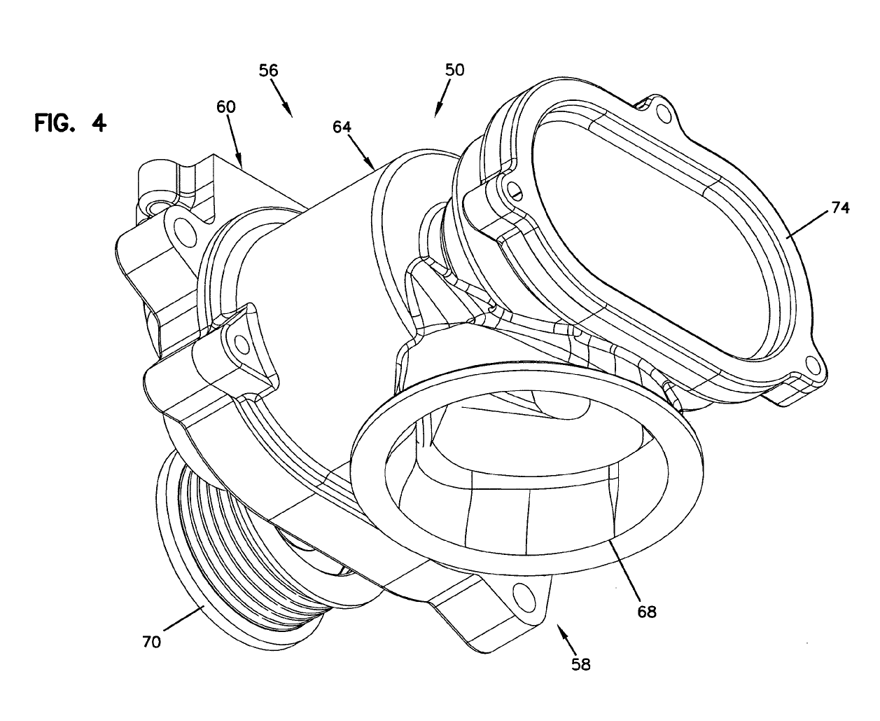

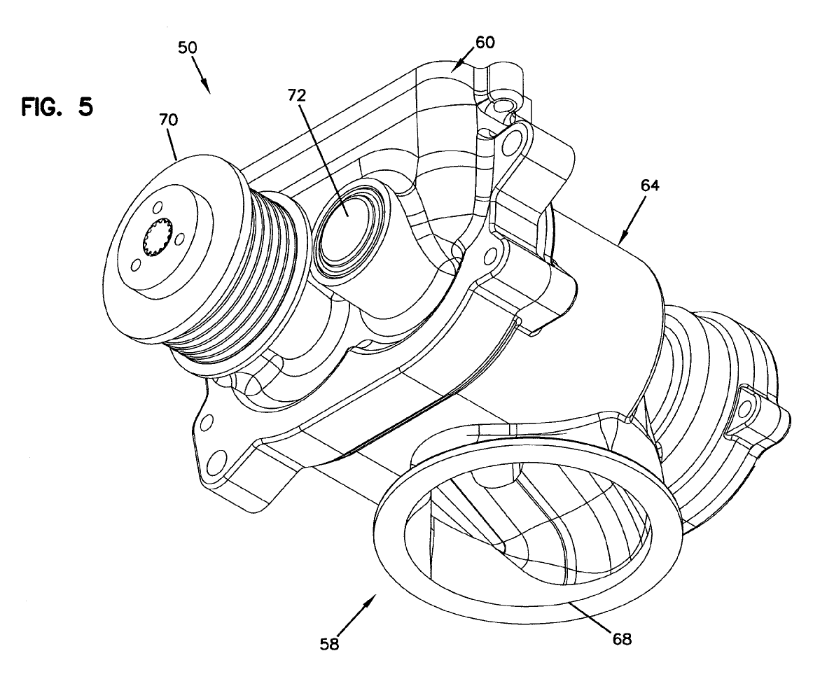

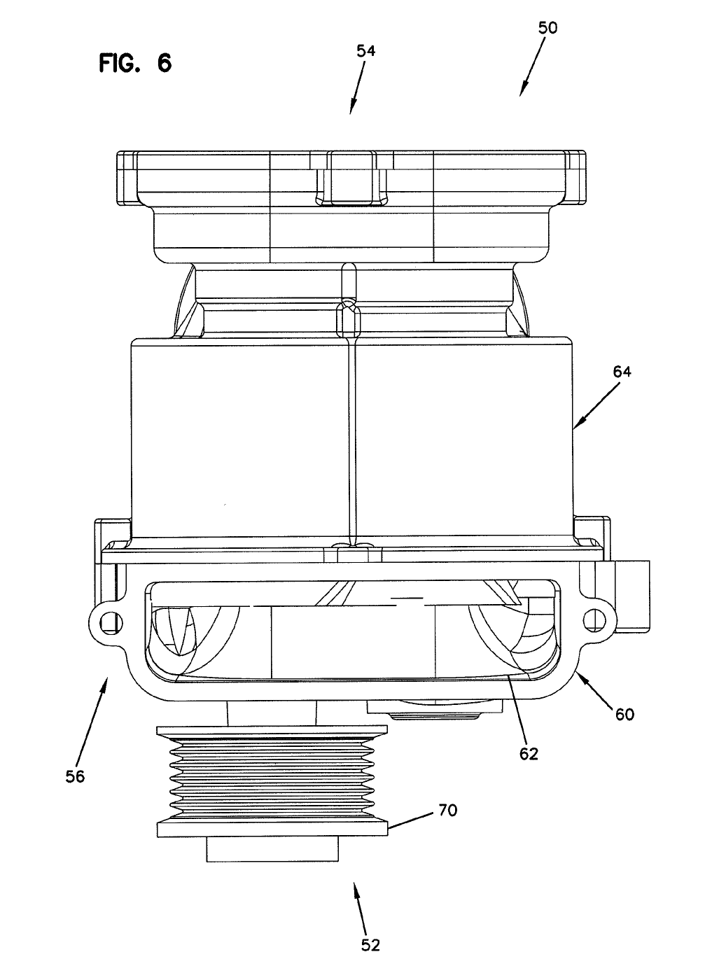

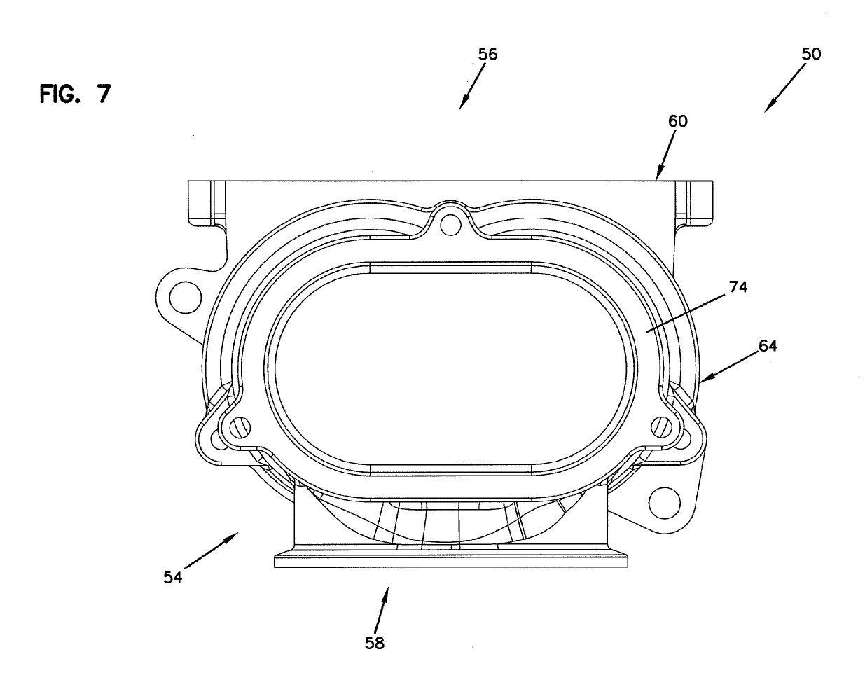

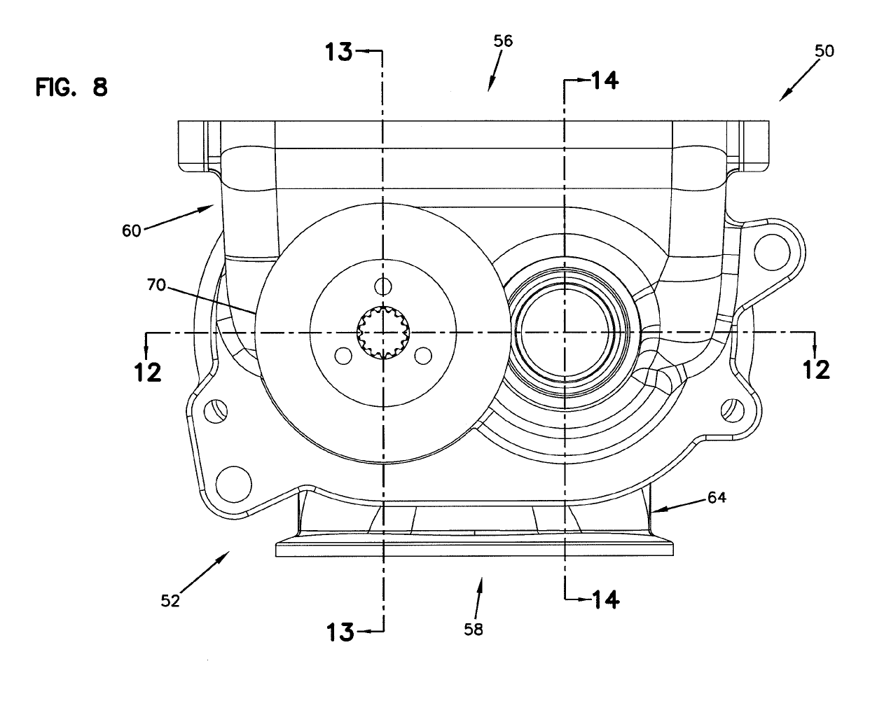

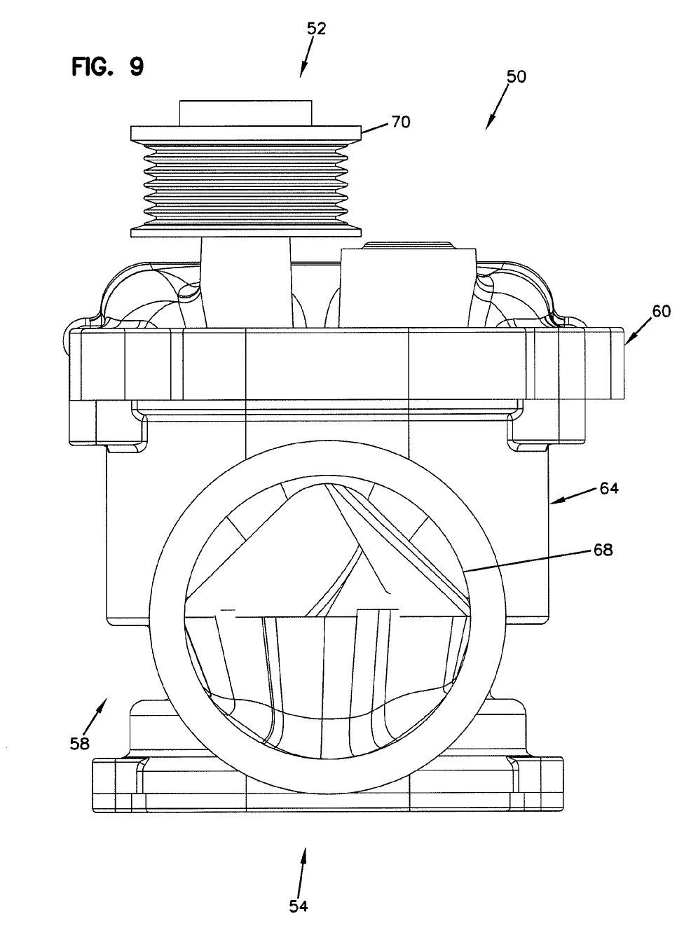

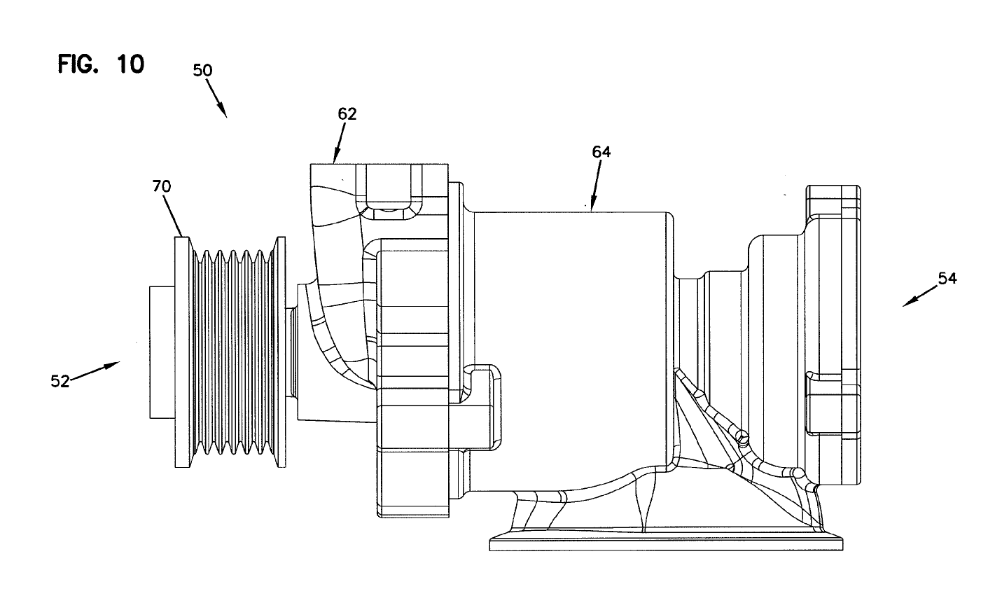

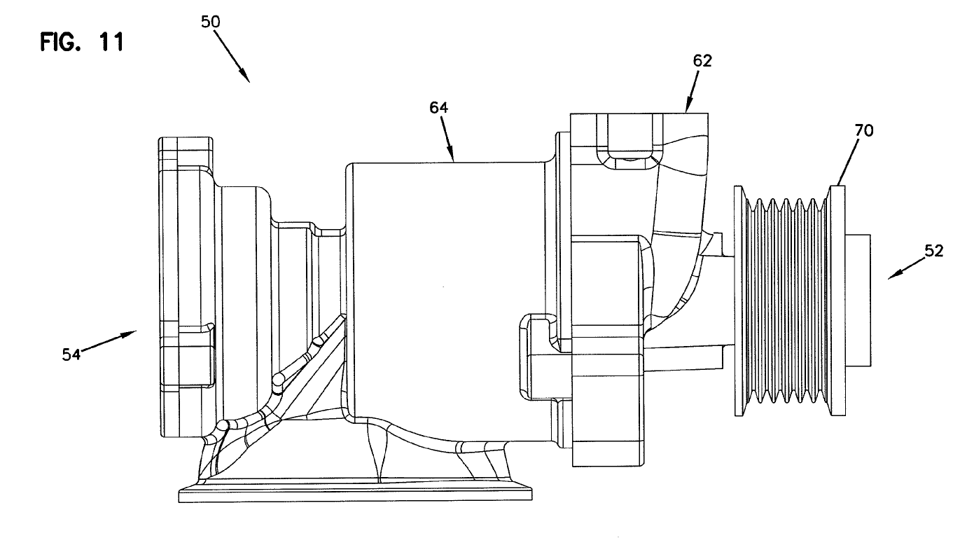

FIGS. 2-14 illustrate a roots-type blower 50 in accordance with the principles of the present disclosure. The roots-type blower 50 includes a front side 52, a rear side 54, a top side 56, and a bottom side 58. The front side 52 of the roots-type blower 50 is defined by an inlet housing 60 defining a blower inlet 62. The inlet 62 is shown facing upward, but could face in other directions (e.g., laterally) as well. The roots-type blower 50 also includes a rotor bore housing 64 that couples to the inlet housing 62 at an alignment interface 66 (see FIGS. 3, 13 and 14). It will be appreciated that the inlet housing 66 and the rotor bore housing 64 may be coupled together using fasteners or by another connection technique such as adhesive (e.g., ultraviolet light curable adhesive). The rotor bore housing 64 defines a blower outlet 68 positioned at the bottom side 58 of the roots-type blower 50. The blower outlet 68 is shown facing in a downward direction, but in alternative embodiments could face in other directions as well (e.g., laterally). The roots-type blower 50 also includes a drive pulley 70 and a bearing cap 72 mounted to the inlet housing 60 at the front side of the roots-type blower 50. A gear chamber cover 74 (see FIGS. 3 and 4) is secured to the rotor bore housing 64 at the rear side 54 of the roots-type blower 50.

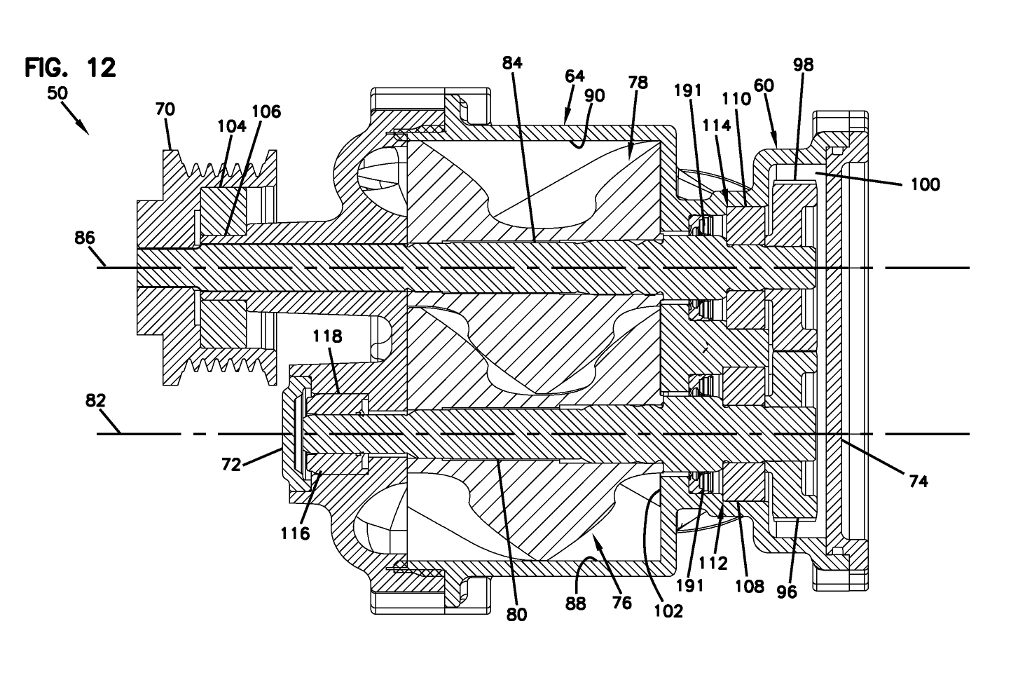

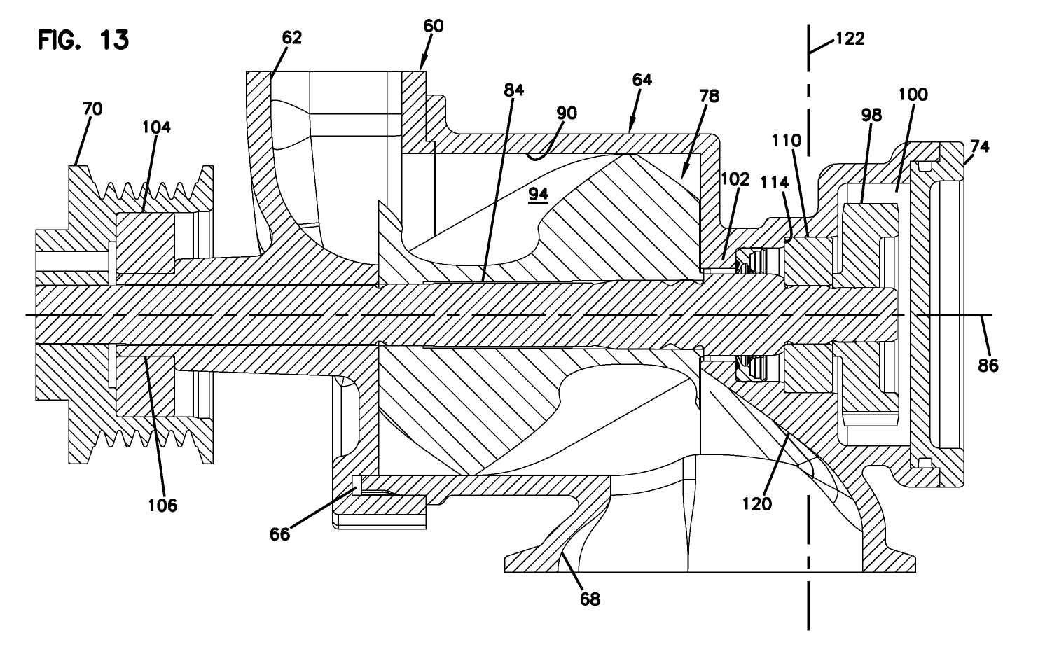

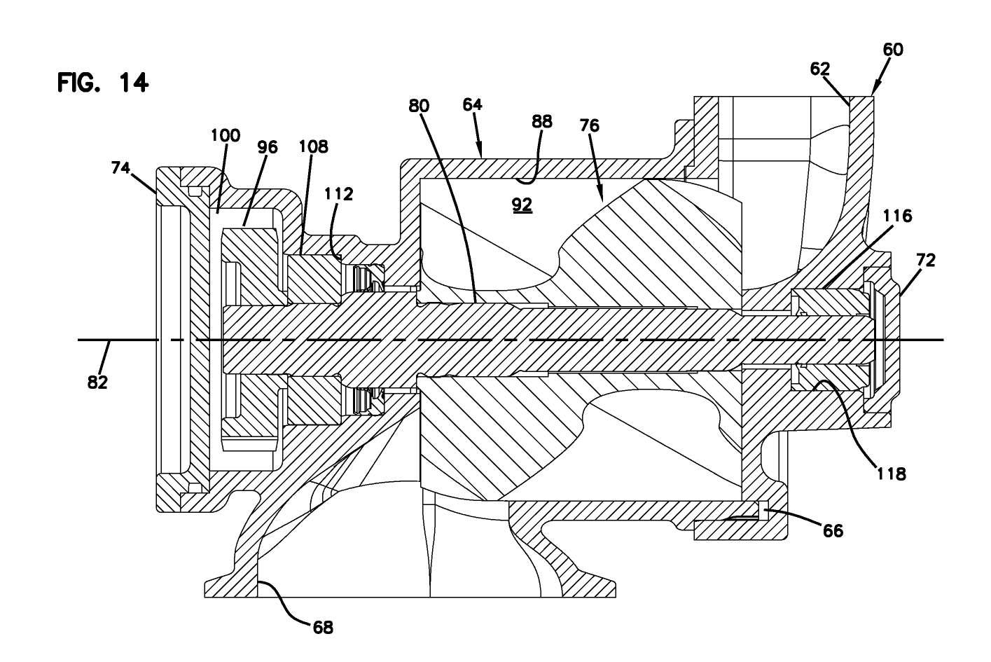

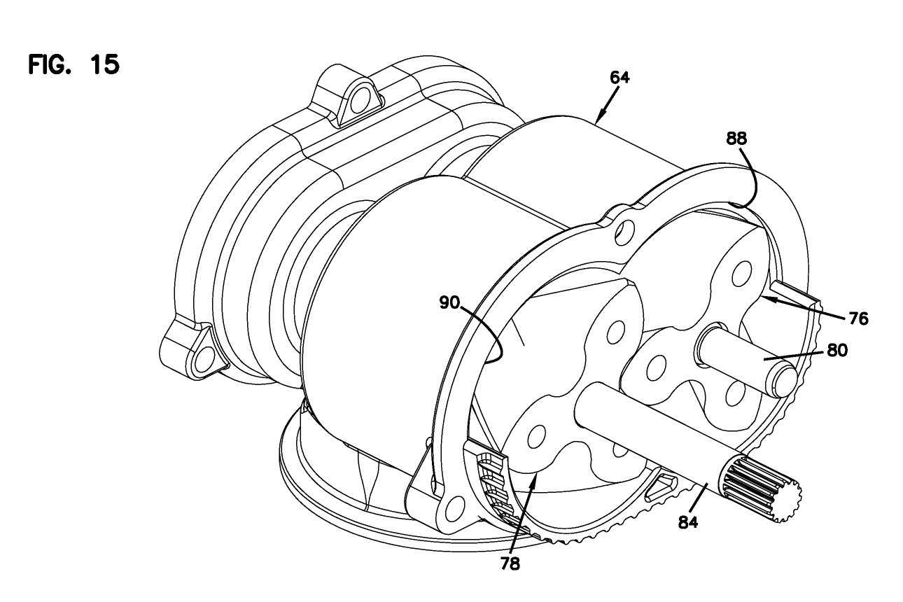

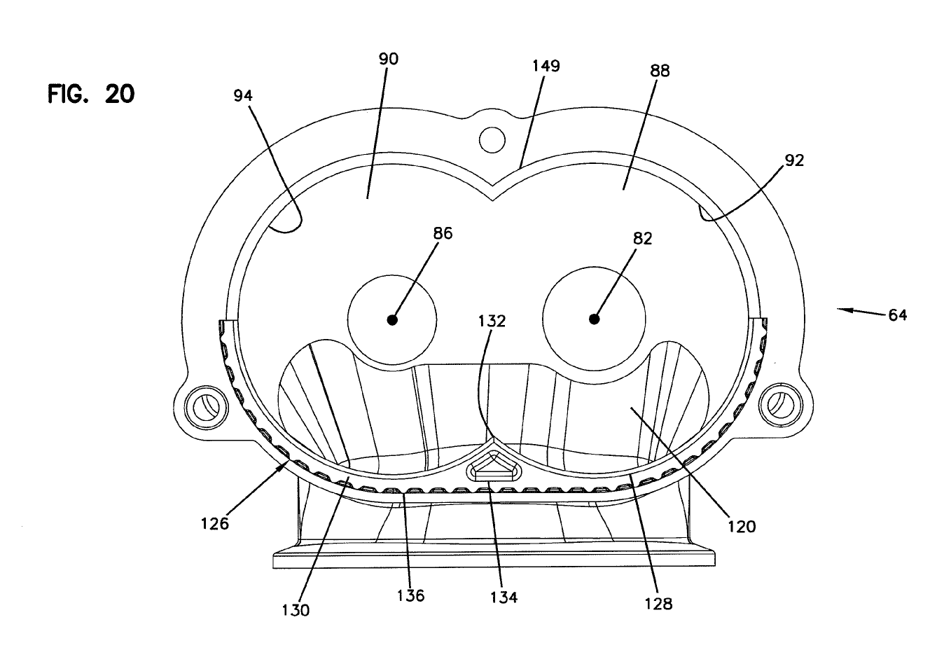

Referring to FIGS. 12-15, the roots-type blower 50 also includes a first roots-type rotor 76 and a second roots-type rotor 78. The first roots-type rotor 76 includes a first rotor shaft 80 aligned along a first rotor shaft axis 82. The second roots-type rotor 78 includes a second rotor shaft 84 aligned along a second rotor shaft axis 86. The first and second rotor shaft axes 80, 82 are preferably parallel. The first and second roots-type rotors 76, 78 are respectively positioned within first and second rotor bores 88, 90 defined by the rotor bore housing 64. At least portions of the first and second rotor bores 88, 90 are preferably cylindrical. For example, the first rotor bore 88 includes a first cylindrical portion 92 (see FIGS. 14 and 20) having a radius of curvature generally centered on the first rotor shaft axis 82 such that the first cylindrical portion 92 curves about the first rotor shaft axis. Similarly, the second rotor bore 90 includes a second cylindrical portion 94 (see FIGS. 13 and 20) having a radius of curvature generally centered on the second rotor shaft axis 86 such that the second cylindrical portion 94 curves about the second rotor shaft axis 82. Thus, the first and second cylindrical portions 92, 94 preferably define rotor bore axes that are coextensive with the first and second rotor shaft axes 82, 86.

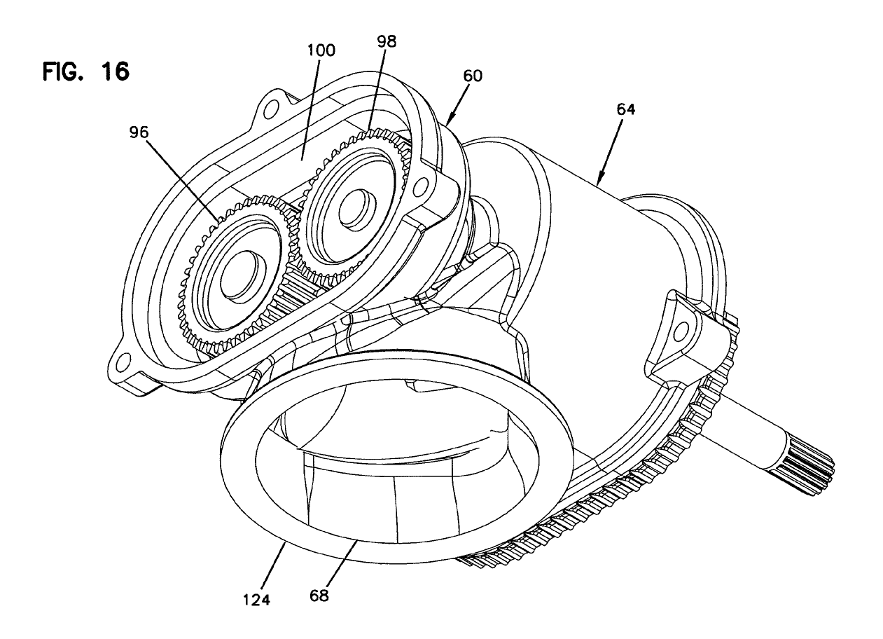

The first roots-type rotor 76 is configured to rotate within the first rotor bore 88 and the second roots-type rotor 78 is configured to rotate within the second rotor bore 90. Intermeshing timing gears 96, 98 (see FIGS. 12 and 16) transfer torque between the first and second rotor shafts 80, 82 and thereby coordinate rotation between the first and second roots-type rotors 76, 78. The first timing gear 96 is connected to the rear end of the first rotor shaft 80 by a torque transmitting connection such as a splined connection. Similarly, the second timing gear 98 is connected to the rear end of the second rotor shaft 86 by a torque transmitting connection such as a splined connection. The first and second timing gears 96, 98 are positioned within a gear chamber 100 defined by the rotor bore housing 64. The gear chamber 100 is separated from the first and second rotor bores 98, 100 by an intermediate divider wall structure 102 of the rotor bore housing 64. The gear chamber 100 is enclosed by the gear chamber cover 74 which can be removed to access the timing gears 96, 98. The gear chamber 100 can contain lubricating oil or grease. Seals 191 (see FIG. 12) can be used to prevent lubricating oil from leaking from the gear chamber 100 into the rotor bores 88, 90.

Torque for rotating the first and second roots-type rotors 76, 78 can be provided by the drive pulley 70. For example, when the roots-type blower 50 is being used as a supercharger, the drive pulley 70 can be rotated by a belt driven by the crankshaft of the engine being supercharged. As shown at FIG. 12, the drive pulley 70 is coupled to the front end of the second rotor shaft 84 by a torque transmitting connection such as a splined connection. The drive pulley 70 is mounted for rotation relative to the inlet housing 60 by a bearing 104. The bearing 104 mounts on a bearing mounting stub 106 that projects forwardly from the main body of the inlet housing 60. The bearing 104 allows the drive pulley 70 to rotate relative to the inlet housing 60 about the second rotor shaft axis 86. The bearing 104, through the drive pulley 70, also functions to rotationally support the second rotor shaft 84 thereby allowing the second rotor shaft 84 to rotate relative to the inlet housing 60 about the second rotor shaft axis 86.

The splined connection between the pulley 70 and the second rotor shaft 84 allows for relative sliding movement between the drive pulley 70 and the second rotor shaft 84. In this way, the connection can compensate of differences in thermal growth between the shaft 84 and the housing (e.g., the inlet housing and/or the rotor bore housing). Such compensation can help prevent excessive loading of the bearing 104 and/or the bearing 110. As shown at FIG. 12, the drive pulley 70 and the timing gears 96, 98 are positioned at opposite ends/sides of the roots-type blower 50 with the first and second rotor bores 88, 90 positioned in a region generally between the drive pulley 70 and the timing gears 96, 98.

The first and second roots-type rotors 76, 78 are supported for rotation relative to the inlet housing 60 and the rotor bore housing 64 by a relatively simple bearing configuration. For example, the first and second rotor shafts 80, 84 are supported adjacent there rearward ends by bearings 108, 110 (see FIG. 12). The bearing 108 is mounted within a first bearing pocket 112 defined by the rotor bore housing 64 and the bearing 110 is mounted within a second bearing pocket 114 defined by the rotor bore housing 64. In certain embodiments, the bearings 108, 110 can be press fit within their respective first and second bearing pockets 112, 114 (see FIG. 12). In other embodiments, the bearings 108, 110 can be molded into the first and second bearing pockets 112, 114 using an insert molding technique or other molding techniques. The bearings 108, 110 support the rearward ends of the first and second rotor shafts 80, 84 to permit the shafts 80, 84 to rotate about their respective axes 82, 86 relative to the rotor bore housing 64. The forward end of the first rotor shaft 80 is rotatably supported by a bearing 116 (see FIG. 12) mounted within a bearing pocket 118 (see FIG. 12) defined by the inlet housing 60. The bearing pocket 118 is covered by the bearing cap 72. As described above, the forward end of the first rotor shaft 86 is supported for rotation about the second rotor shaft axis 86 by the bearing 104 on which the drive pulley 70 is mounted.

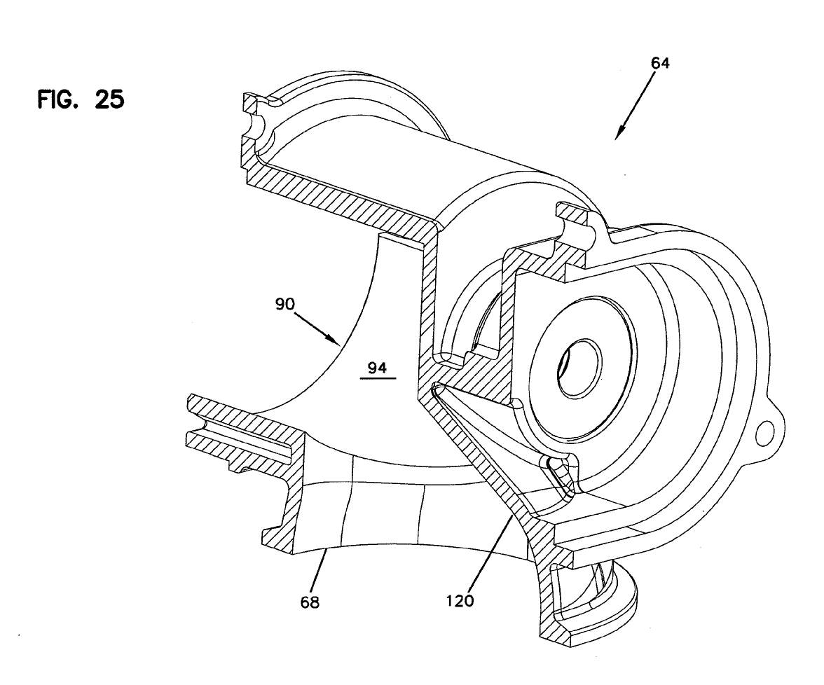

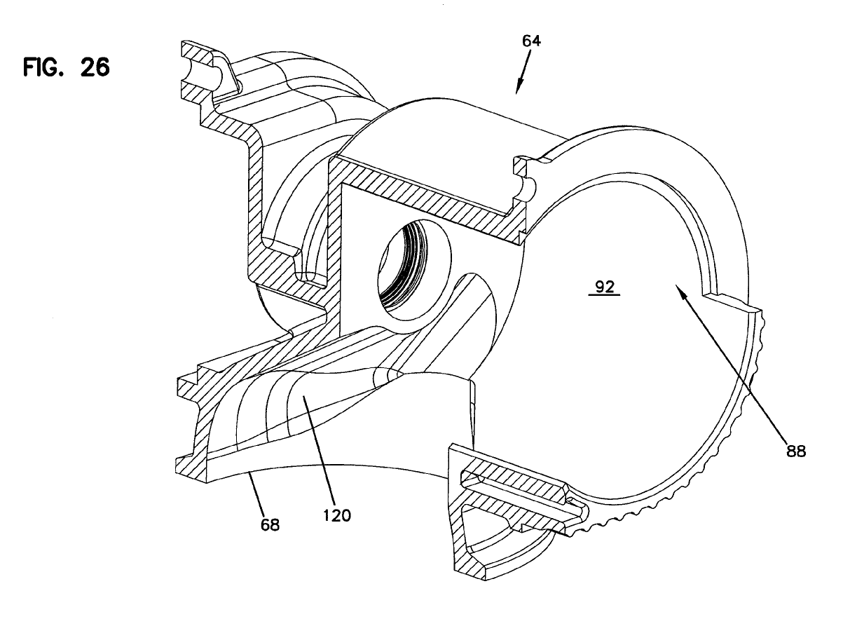

Referring to FIGS. 13, 25 and 26, the special arrangement of the blower outlet 68 relative to the bearings 108, 110 and the timing gears 96, 98 allows for a relatively compact configuration. Specifically, the rotor bore housing 64 includes a contoured surface 120 (see FIGS. 13, 20, 25 and 26) that angles downwardly from the first and second rotor bores 88, 90 to the blower outlet 68. As the contoured surface 120 extends toward the blower outlet 68, the contoured surface 120 extends directly beneath the bearings 108, 110 and also directly beneath portions of the timing gears 96, 98. Thus, the blower outlet 68 at least partially overlaps with the bearings 108, 112 and the timing gears 96, 98 in a front-to-rear orientation so as to allow the overall length of the roots-type blower 50 to be relatively compact. As shown at FIG. 13, the bearings 108, 110 and the blower outlet 68 are intersected by a reference plane 122 that is perpendicular relative to the first and second rotor shaft axes 82, 86.

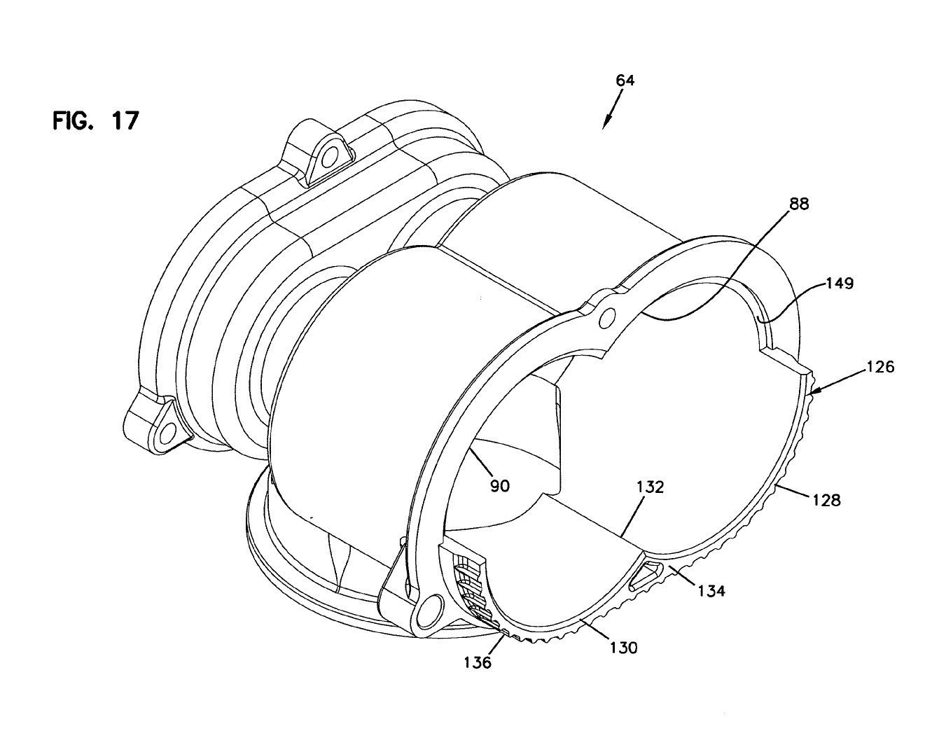

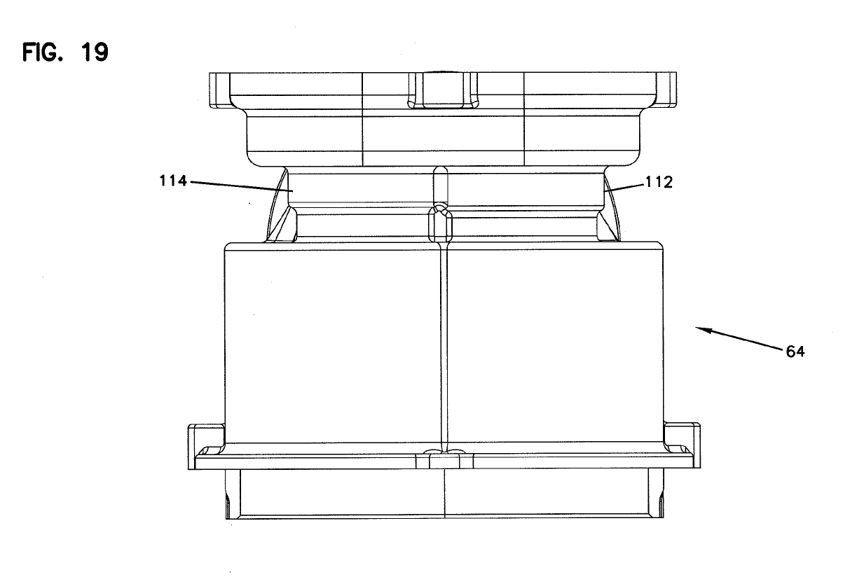

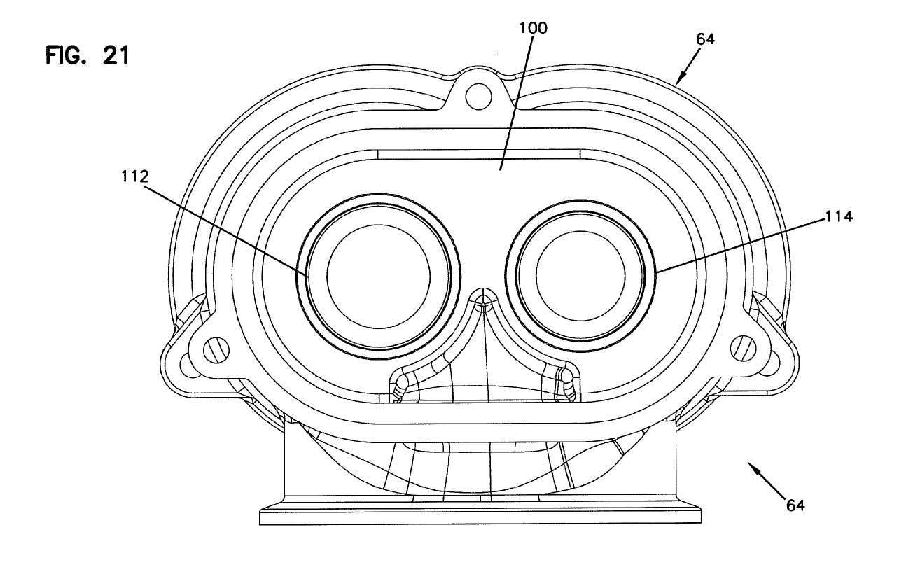

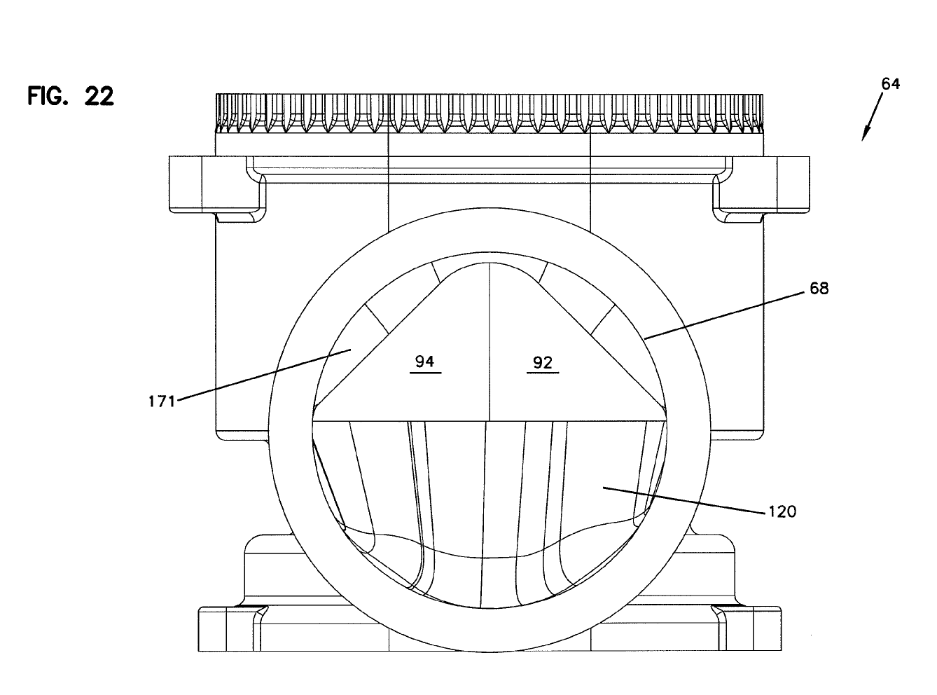

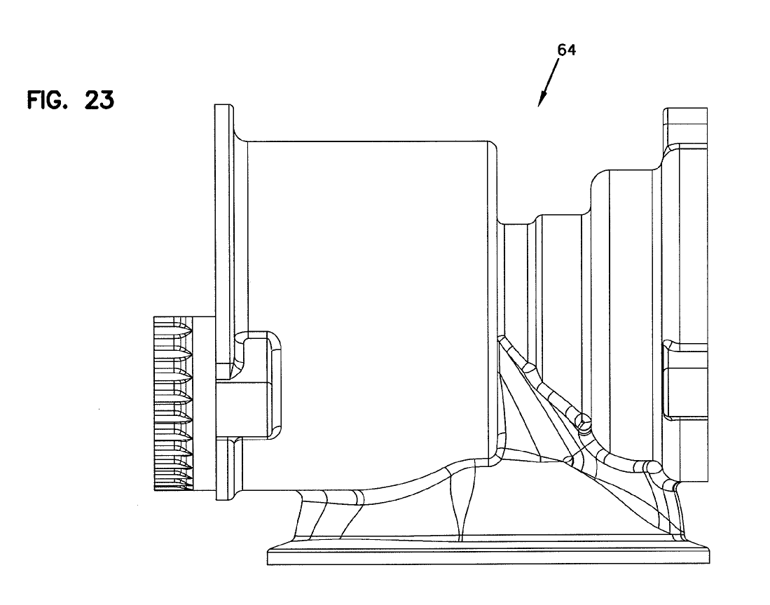

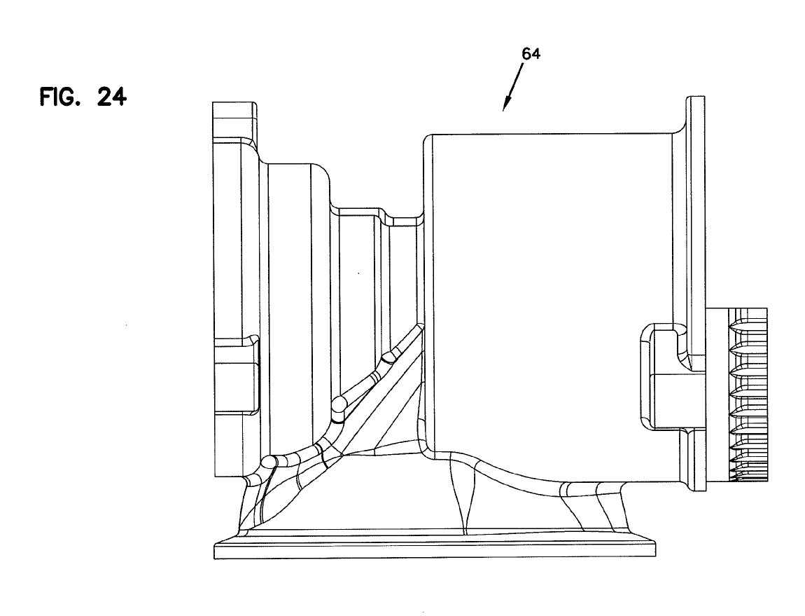

FIGS. 17-26 depict the rotor bore housing 64 from various views. In a preferred embodiment, the rotor bore housing 64 has a polymeric construction and is manufactured using a molding process such as an injection molding process. In certain embodiments, the polymeric construction includes a polymeric material as a base material, and also includes reinforcing elements (e.g., reinforcing fibers such as glass fibers, aramid yarn, carbon fibers, etc.) that help structurally reinforce of the rotor bore housing 64. Example polymeric base materials include polyethylene terephthalate (PET) and polyamides/nylons such as polyamide (nylon) 66 (PA66), polyamide (nylon) 46 (PA46) and Polyphthalamide (PPA). In the depicted embodiment, the entire rotor bore housing 64 is molded as a single, unitary, seamless piece. Thus, the rotor bore housing 64 provides a one-piece, seamless, unitary housing that includes both first and second rotor bores 88, 90 and the corresponding bearing pockets 112, 114.

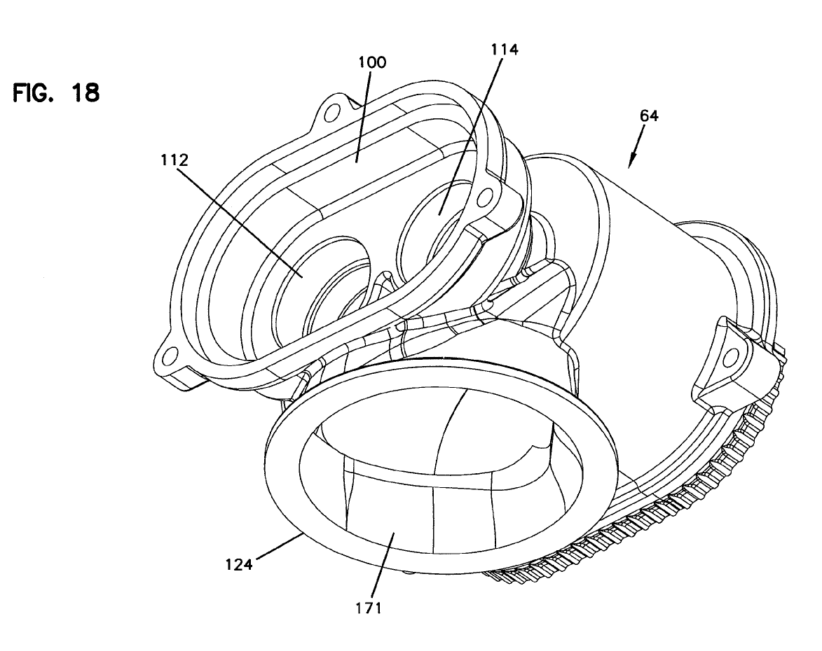

Referring to FIG. 18, a flange 124 is provided at the end of the blower outlet 68. The outlet passage defines a bell-like curvature 171 that extends to the flange 124.

Referring to FIGS. 17 and 20, the rotor bore housing 64 includes an axial projection 126 that projects forwardly from a main body of the rotor bore housing 64 at the front end of the rotor bore housing 64. The axial projection 126 includes a first cylindrical portion 128 corresponding to the first rotor bore 88 and a second cylindrical portion 130 corresponding to the second rotor bore 90. The first and second cylindrical portions 128, 130 meet at an apex 132. The first and second cylindrical portions 128, 130 form a generally triangular mid-portion 134 adjacent to the apex 132. In certain embodiments, one or more reinforcing members (e.g., reinforcing rods, reinforcing bars, etc.) can be molded within the triangular mid-portion to enhance the structural characteristics of the rotor bore housing 64 and to assist in reducing vibrations and associated noise. Referring still to FIG. 17, a plurality of axial ribs 136 are provided on an exterior surface of the main body of the axial projection 126. The axial ribs 136 are parallel to one another and extend parallel to the first and second rotor shaft axes 82, 86.

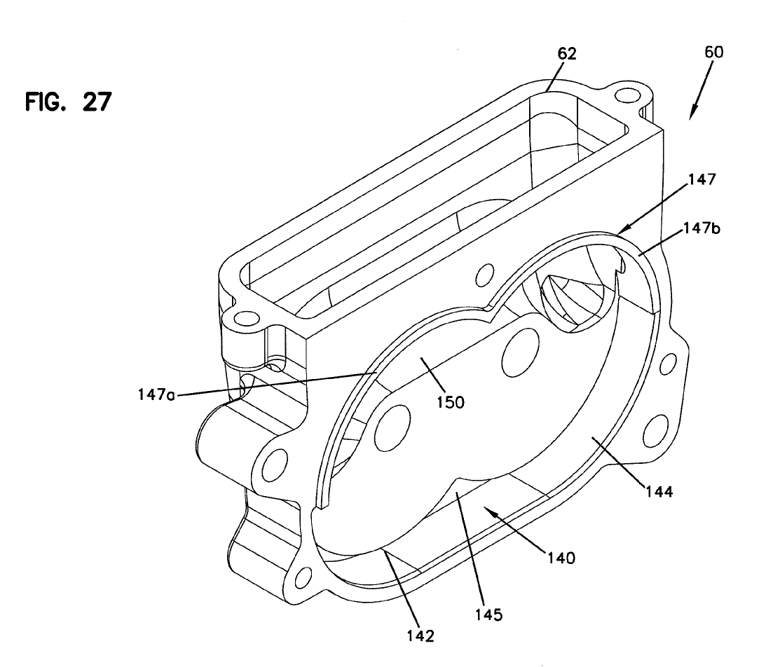

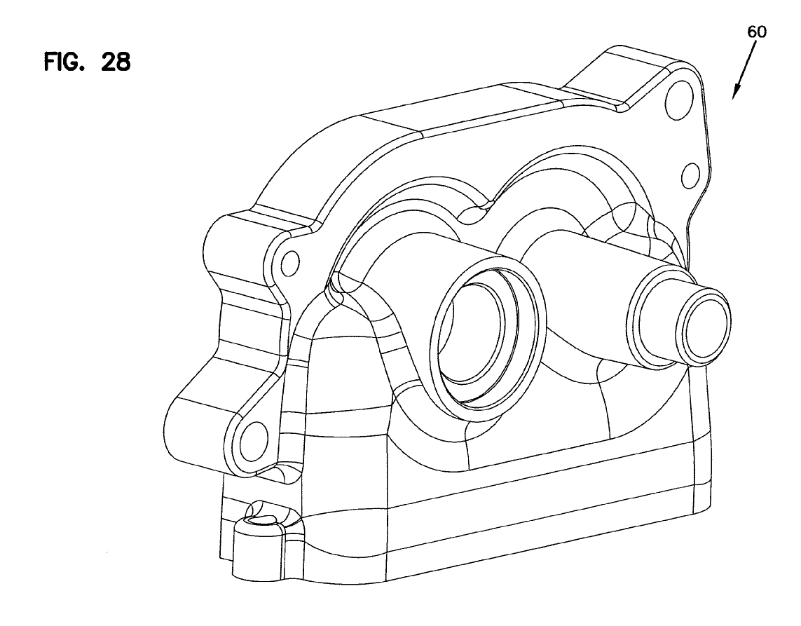

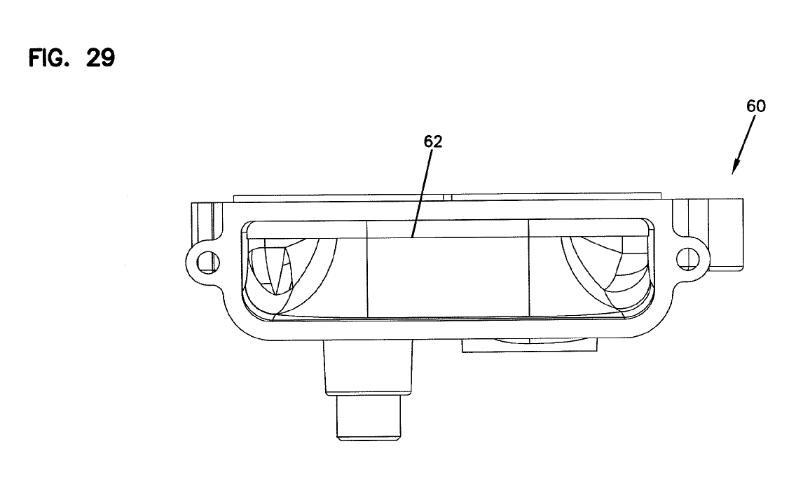

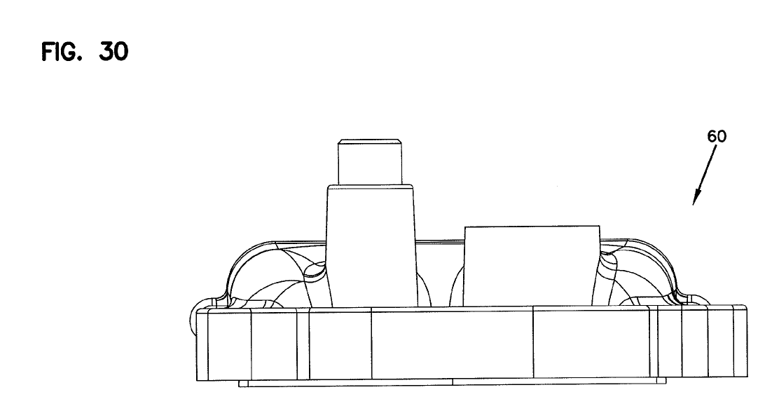

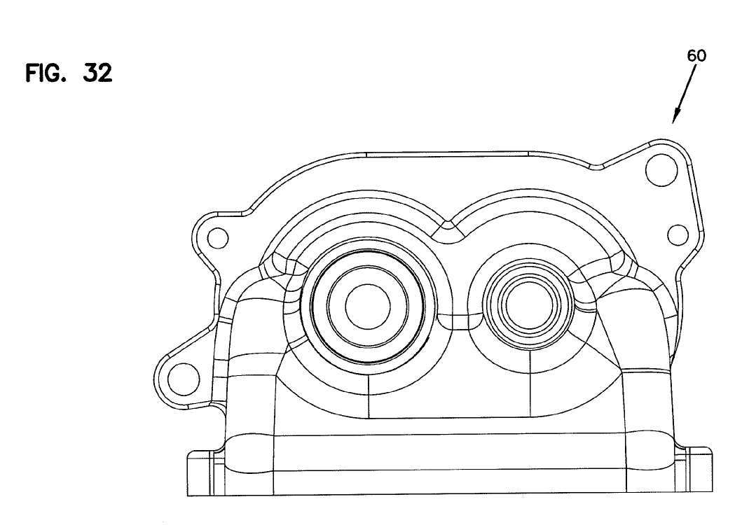

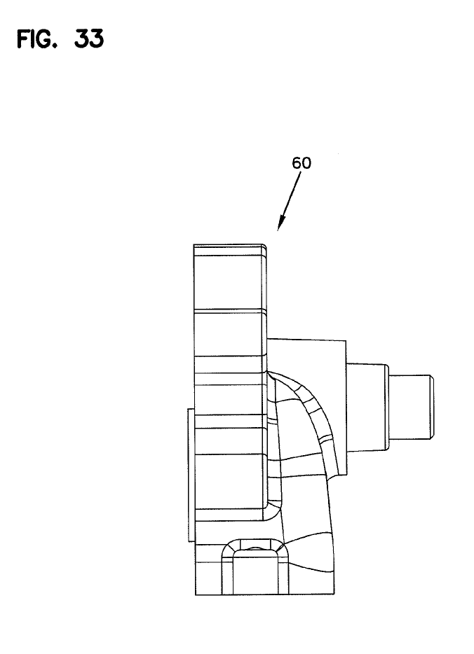

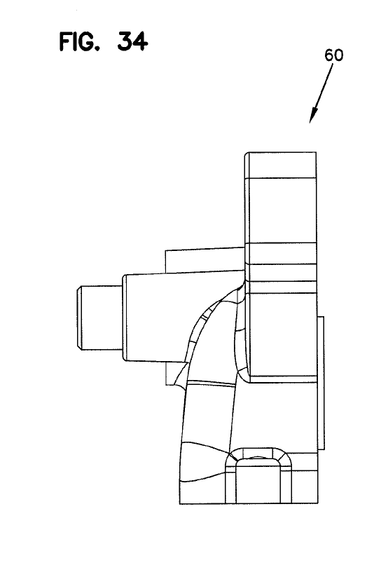

FIGS. 27-34, depict the inlet housing 60 from various views. In a preferred embodiment, the inlet housing 60 is constructed of a metal material such as aluminum. In certain embodiments, the inlet housing 60 is a cast part manufactured from aluminum or other metal. In other embodiments, the inlet housing 60 could have a polymeric construction. For example, in certain embodiments, the inlet housing 60 can be constructed of a polymeric material with reinforcing inserts such as metal inserts for reinforcing the housing at strategic locations. In one embodiment, such insert can be provide for enhancing the ability of the inlet housing 60 to support a belt load applied to the pulley 70.

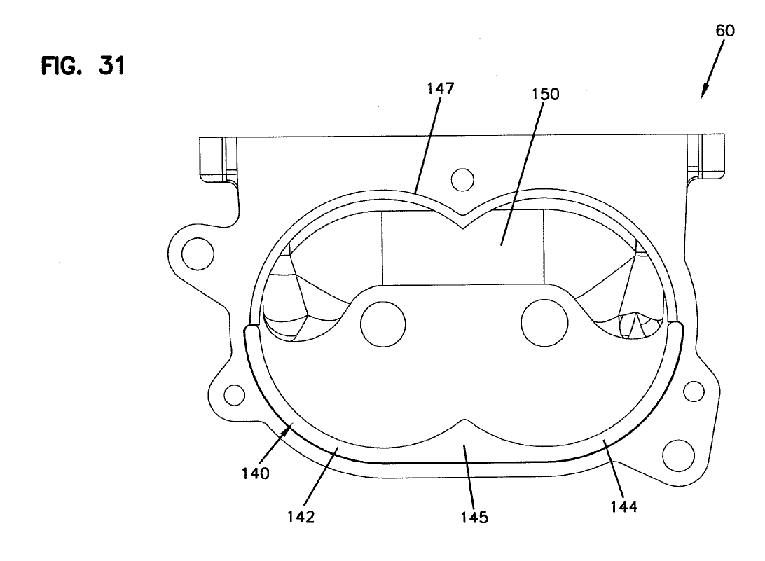

One advantage of constructing the inlet housing 60 of metal is that the inlet housing 60 can be manufactured according to relatively precise tolerances. In certain embodiments, the inlet housing 60 is constructed of metal and includes a precisely tolerance (e.g., precision machined) piloting receptacle 140 that is sized to receive the axial projection 126 to provide the alignment interface 66 (see FIG. 13). Similar to the axial projection 126, the piloting receptacle 140 has a first cylindrical portion 142 and a second cylindrical portion 144 configured to be concentric with the rotor shaft axes 82, 86 when the inlet housing 60 is coupled to the rotor bore housing 64. The piloting receptacle 140 also has a triangular mid-portion 145. It will be appreciated that the piloting receptacle 140 is sized to receive and pilot axial projection 126. When the axial projection 126 mates with the piloting receptacle 140, contact between the walls of the receptacle 140 and the axial projection 126 forces the axial projection 126 toward a position where the cylindrical portions 128, 130 are concentric with respect to the first and second rotor shaft axes 82, 86. Thus, the receptacle 140 provides a pilot function that assists in ensuring the concentricity of the first and second rotor bores 88, 90. The inlet housing 60 also includes a piloting projection 147 (see FIGS. 27 and 31) that mates with a corresponding receptacle 149 (see FIG. 17) of the rotor bore housing 64. The projection 147 has curved portions (e.g., cylindrical portions 147a, 147b) that match the desired curvatures and concentricity of the rotor bores 88, 90.

As shown at FIG. 27, the blower inlet 62 is generally rectangular in shape. A contoured, angled surface 150 within the inlet housing 60 positions flow from the blower inlet 62 to the first and second rotor bores 80, 90 when the inlet housing 60 is mounted to the rotor bore housing 64.

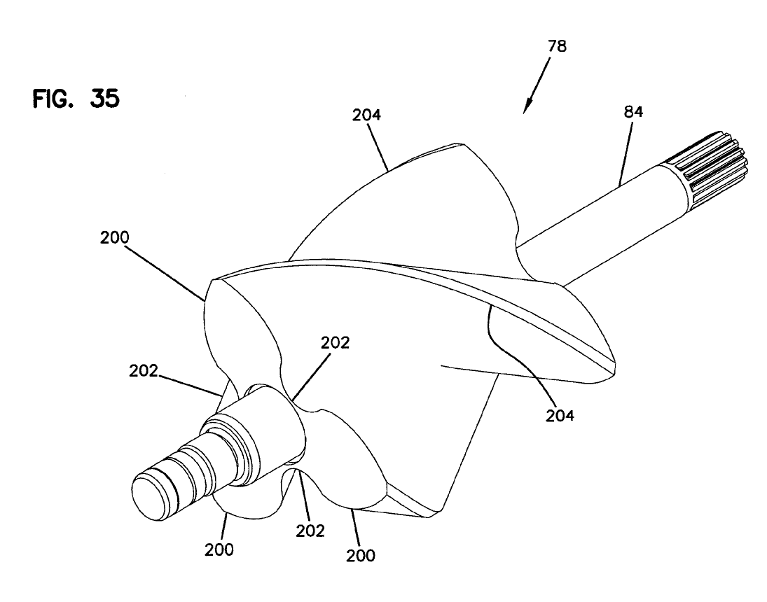

FIG. 35 shows the second roots-type rotor 78. The depicted roots-type rotor 78 includes projections 200 that project outwardly from the corresponding rotor shaft 80, 84. Pockets 202 are defined between the projections 200. In a preferred embodiment, peripheral edges 204 of the projections 200 are sharp so as to function as cutting blades. The rotors 76, 78 preferably have a metal construction. It will be appreciated that the first roots-type rotor 76 has a similar projection and pocket configuration. It will also be appreciated that other roots-type rotor configurations can be used as well.

In certain embodiments, the rotor bore housing 64 can be molded with the first and second rotor bores 88, 90 slightly undersized. During assembly of the roots-type blower 50, the roots-type rotors 76, 78 are mounted within the rotor bores 88, 90. At initial startup, the roots-type rotors 76, 78 are rotated about their respective axes 82, 86. As this occurs, the cutting edges of the rotors 76, 78 cut away portions of the rotor bore housing 64 defining the rotor bores 88, 90. This type of cutting process ensures that the inner surfaces of the rotor bores 88, 90 have a shape that matches the shapes defined by the peripheral edges 204 of the roots-type rotors 76, 78 as the roots-type rotors 76, 78 are revolved about their respective axes 82, 86. In other words, the sharp edges of the rotors 76, 78 cut the plastic rotor bores to an exact diameter thereby reducing leakage and improving efficiency. This relatively exact sizing of the rotor bores 88, 90 ensures that air is inhibited from passing between the outer peripheries of the rotors 76, 78 and the wall of the rotor bore housing 64 along the cylindrical portions 92, 94. This assists in enhancing the volumetric and thermal efficiency of the device. To prevent air from leaking past the ends of the rotors and lowering efficiency during use of the blower, it is preferred for the shaft holes of the rotor housing to be sized (e.g., molded or shaped with inserts) to be in close proximity to the shafts of the rotors. In certain embodiments, the shaft holes are sized smaller than bases/roots of the projections/blades of the rotors 76, 78 on the rotor bore side.

In certain embodiments, the roots-type blower 50 is relatively small and is adapted for use as a supercharger for relatively small engines. For example, in one embodiment, the rotor bores 88, 90 define a combined volume equal to or less than 250 cubic centimeters and the roots-type blower 50 is adapted for use as a supercharger with an engine having a volume of less than one liter, or in the range of 0.6-1.0 liters. Of course, aspects of the present disclosure are applicable to larger sized blowers as well.

As indicated above, it is desirable for the design to be configured for inhibiting leakage between the roots-type rotors 76, 78 and the cylindrical portions 92, 94 of the rotor bore housing 64. In this regard, it is preferred to use a molding process in which the rotor bores 88, 90 are provided with a draft angle less than 2 degrees, or more preferably less than 1 degree, or even more preferably equal to 0.

In certain embodiments, it is desirable to avoid the use of fasteners. For example, various components can be connected together through the use of adhesive such as a ultraviolet light curable adhesive. In one embodiment, the rotor bore housing 64 is connected to the inlet housing 60 by an adhesive such as an ultraviolet light curable adhesive. It will be appreciated that while the blower inlet 62 is defined by a metal part in the form of an inlet housing 60, the bearings 108, 110, the timing gears 96, 98 and a majority of each of the roots-type rotors 76, 80 are provided within the rotor bore housing 64 which is preferably polymeric (e.g., plastic). Similarly, the blower outlet 68 is provided on the polymeric rotor bore housing 64. It will be appreciated that the polymeric construction of the rotor bore housing 64 has improved sound deadening and vibration dampening characteristics as compared to metal. Thus, the use of the polymeric rotor bore housing 64 can assist in dampening noise created by air rushing through the blower outlet 68 and can also assist in dampening or otherwise inhibiting noise associated with gear rattling.

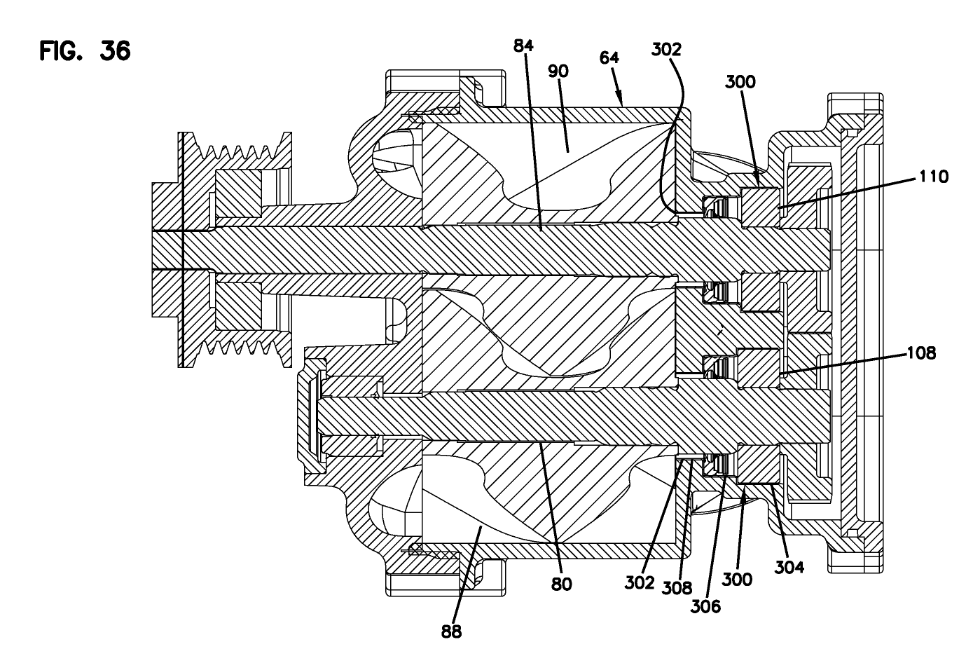

In certain embodiments (see FIG. 36), plastic or metal shields 300 are provided between the bearings 108, 110 and the rotor bore housing 64. In certain embodiments, the shields 300 can be cup-shaped with center holes 302 for receiving the rotor shafts 80, 84. The shields 300 are depicted having a stepped configuration. The stepped configuration includes a first, second and third annular rings 304, 306 and 308 at are spaced from one another by radial steps. The first annular rings engage the outer races of the bearings 108, 110. The stepped configuration preferably conforms to the shape of a bore within the interior of the rotor bore housing 64. The third annular rings 308 can be provided between the rotor bore housing 64 and the rotor shafts 80, 84 to assist in providing a bore sealing surface at the divider wall between the rotor bores 88, 90 and the gear chamber 100.

Prior to injection molding the rotor bore housing 64, the metal shields 300 are pressed onto the bearings 108, 110 to prevent plastic from flowing into and contaminating the bearings 108, 110 during the injection molding process. As shown at FIG. 36, the seals are pressed within the annular rings 306 and the bearings 108, 110 are pressed within the annular rings 304. During the injection molding process, the injection molding die closes and seals on first faces/sides of the bearings 108, 110 while the die also closes and seals on the shields 300 on opposite faces/sides of the bearings 108, 110 preventing plastic from entering the bearings 108, 110 during the insert molding process. In certain embodiments, the radial step between the annular rings 304, 306 can correspond to a race thickness of the bearings. In certain embodiments, the annular rings 308 can fit closely about the rotor shafts so as to inhibit air from leaking through the shaft bores during operation of the blower.

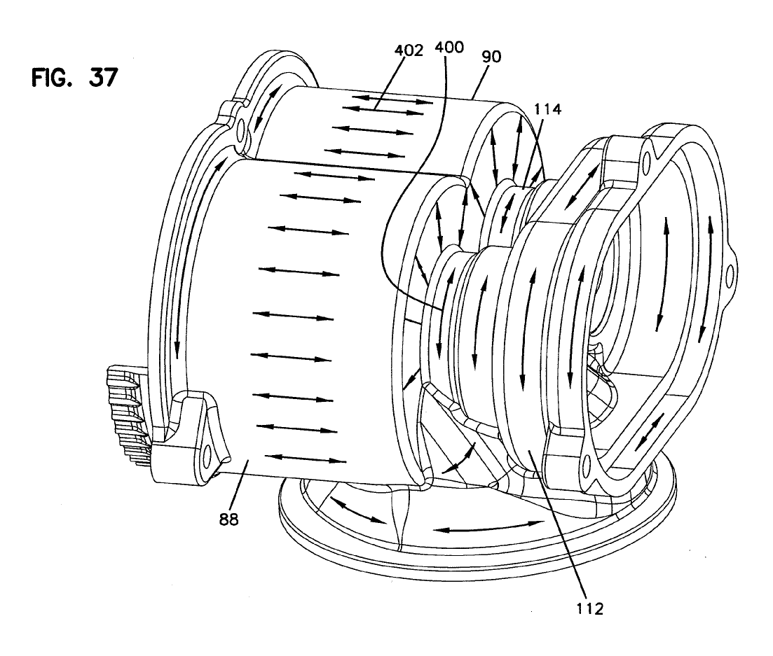

As indicated above, the rotor bore housing 64 preferably has a polymeric construction. In certain embodiments, reinforcing fibers (e.g., aramid fibers, glass fibers, carbon fibers, etc.) can be embedded in the polymeric base material forming the rotor bore housing 64. Shown at FIG. 37, the rotor bore housing 64 is preferably injection molded taking into consideration an orientation strategy for the reinforcing fibers. For example, the reinforcing fibers are oriented in a generally circumferential orientation along the bearing pockets 112 and 114 (see arrow 400) and are oriented in a generally axial orientation (e.g., an orientation generally parallel to the rotor shaft axes 82, 86 as shown by arrows 402) along the first and second rotor bores 88, 90.

From the forgoing detailed description, it will be evident that modifications and variations can be made without departing from the spirit and scope of the disclosure.

1. A Roots blower comprising:
a rotor bore housing having a molded, one-piece polymeric construction to define a full thickness of the housing, defining a first rotor bore with a first inner surface formed by the polymeric construction and defining a second rotor bore with a second inner surface formed by the polymeric construction;
a first Roots rotor having a first rotor shaft aligned along a first rotor axis and a second Roots rotor having a second rotor shaft aligned along a second rotor bore axis, the first and second Roots rotors being respectively positioned within the first and second rotor bores, the first and second Roots rotors being rotatable relative to the rotor bore housing about their respective first and second rotor axes, the first and second rotor bore axes being relatively positioned such that the first and second Roots rotors intermesh with one another when the first and second Roots rotors are rotated about their respective first and second rotor axes, the first rotor shaft being supported by the first bearing and the second rotor shaft being supported by the second bearing.

2. The Roots blower of claim 1, wherein the first and second rotor bores each have a draft angle less than 2 degrees.

3. The Roots blower of claim 1, wherein the first and second rotor bores each have a draft angle equal to zero.

4. The Roots blower of claim 1, wherein the molded polymeric construction includes a polymeric base material and reinforcing fibers embedded within the base material.

5. The Roots blower of claim 4, wherein the rotor bore housing includes first and second cylindrical pocket-defining walls that respectively define first and second bearing pockets, and wherein the reinforcing fibers are aligned in a circumferential orientation within each of the first and second cylindrical pocket defining walls.

6. The Roots blower of claim 5, wherein the rotor bore housing includes first and second rotor bore-defining walls that respectively define the first and second rotor bores, and wherein the reinforcing fibers within the first and second rotor bore-defining walls are oriented parallel with respect to the first and second rotor bore axes.

7. The Roots blower of claim 1, wherein the first and second rotor bores have a combined volume less than 250 cubic centimeters.

8. The Roots blower of claim 1, wherein the rotor bore housing defines an outlet in fluid communication with the first and second rotor bores, and wherein the outlet and first and second bearings are relatively positioned such that a reference plane perpendicular to the first and second rotor bore axes intersects the outlet and the first and second bearings.

9. The Roots blower of claim 1, wherein first and second bearings are insert-molded into respective first and second bearing pockets.

10. The Roots blower of claim 9, further comprising a first bearing shield surrounding the first bearing and a second bearing shield surrounding the second bearing, the first and second bearing shields being configured to prevent plastic from contaminating the first and second bearings when the first and second bearings molded within the rotor bore housing.

11. The Roots blower of claim 1, wherein the first and second rotors have cutting edges that cut the rotor bore housing during an initial run-in period to shape the first and second rotor bores.

12. The Roots blower of claim 1, wherein the rotor bore housing has first and second opposite ends spaced-apart from one another along the first and second rotor bore axes, wherein a gear chamber is positioned adjacent the first end, wherein a first bearing is positioned in a first bearing pocket and between the first rotor bore and a first gear, wherein a second bearing is positioned in a second bearing pocket and between the second rotor bore and a second gear, wherein the rotor bore housing defines an outlet between the first sand second ends, wherein the Roots blower also includes an inlet housing that mounts to the second end of the rotor bore housing, the inlet housing defining an inlet in fluid communication with the first and second rotor bores.

13. The Roots blower of claim 12, wherein the inlet housing defines a third bearing pocket co-axially aligned with the first rotor axis, wherein the inlet housing defines a bearing mounting stub co-axially aligned with the second rotor axis, wherein the Roots blower includes third and fourth bearings, wherein the third bearing supports the first rotor shaft and is mounted within the third bearing pocket, wherein the fourth bearing supports the second rotor shaft and is mounted on the bearing mounting stub, and wherein the Roots blower further includes a pulley mounted on the fourth bearing and coupled to the second rotor shaft by a splined connection.

14. The Roots blower of claim 12, wherein the inlet housing is metal.

15. The Roots blower of claim 14, wherein the rotor bore housing and the inlet housing interconnect at an alignment interface, and wherein the alignment interface is configured such that the inlet housing enhances concentricity of the first and second rotor bore about their respective first and second rotor axes.

16. The Roots blower of claim 15, wherein the alignment interface includes a axial projection at the second end of the rotor bore housing that is received within an alignment receptacle defined by the inlet housing.

17. The Roots blower of claim 16, wherein the axial projection and the alignment receptacle include first curved portions that extend about the first rotor axis and second curved portions that extend about the second rotor axis.

18. The Roots blower of claim 17, further comprising a plurality of axial ribs provided on an exterior of the axial projection.

19-23. (canceled)

24. The Roots blower of claim 1, wherein the rotor bore housing defines a first bearing pocket corresponding to the first rotor bore and a second bearing pocket corresponding to the second rotor bore axis, the rotor bore housing further defining a gear chamber, the Roots blower further including a first bearing mounted within the first bearing pocket and a second bearing mounted within the second bearing pocket;

25. The Roots blower of claim 1, further including:
first and second gears positioned within a gear chamber, the first gear being coupled to the first rotor shaft and the second gear being coupled to the second rotor shaft, the first and second gears intermeshing with one another and being configured for transferring torque between the first and second rotor shafts.
